(19) United States
(12) Patent Application Publication
(10) Pub. No.: US 2010/0177335 A1
(43) Pub. Date: Jul. 15, 2010

(54) IMAGE FORMING APPARATUS WITH OPTIONAL DEVICES AND CONTROL METHOD THEREOF

(75) Inventor: Han Sang OH, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/685,761

(22) Filed: Jan. 12, 2010

(30) Foreign Application Priority Data
Jan. 15, 2009 (KR) 2009-3244

(51) Int. Cl. G06F 15/00

(52) U.S. Cl. 358/1.13

(57) ABSTRACT

A method of controlling an image forming apparatus, and an image forming apparatus to perform the method, the method including transmitting a pulse signal from a controller to a first optional device, setting an identification (ID) of the first optional device according to the received pulse signal, and incrementing the pulse signal and transmitting the incremented pulse signal so as to be received by a potential additional optional device

### CROSS-REFERENCE TO RELATED APPLICATIONS

This application claims the benefit under 35 U.S.C. §119(a) of Korean Patent Application No. 2009-0003244, filed on Jan. 15, 2009, in the Korean Intellectual Property Office, the disclosure of which is incorporated herein by reference in its entirety.

### BACKGROUND

1. Field of the Invention

Embodiments of the present general inventive concept relate to an image forming apparatus which easily sets identification of a plurality of optional devices installed therein, and a control method thereof.

2. Description of the Related Art

Generally, an image forming apparatus, such as a printer, a copier, a scanner, and a multifunctional device thereof, includes a variety of optional devices in a main body thereof.

An example of the various optional devices installed in the image forming apparatus is a mailbox. In the image forming apparatus used in a network by multiple users, a user may not confirm a set of sheets output for each user among large sets of sheets stacked in output bins when a large amount of printed sheets are distributed in one output bin. Therefore, mailboxes are used as a sorting device which selectively sorts printed sheets to a plurality of output bins so that the set of printed sheets output for each user is separated from the other sets of sheets.

In conventional mailboxes installed in the image forming apparatus, the number of output bins is predetermined. Accordingly, when using mailboxes having a small number of output bins, user inconvenience results, and when using mailboxes having a large number of output bins, a user is burdened with excessive costs.

Recently, module type mailboxes are additionally mounted in the image forming apparatus so that the mailboxes may be efficiently used.

In this case, the image forming apparatus should recognize the mailboxes to control them even though they are randomly stacked. Therefore, setting of an identification (ID) of each mailbox is required.

Conventionally, since a user has to manually set the ID of each mailbox by confirming a dip switch provided on each mailbox, it may be difficult to install the mailboxes. If the ID of each mailbox is wrongly set, the mailbox may have a probability of malfunction.

### SUMMARY

Example embodiments of the present general inventive concept provide an image forming apparatus to improve convenience and stability by automatically setting IDs of a plurality of optional devices and a control method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image forming apparatus includes a main body to generate a first pulse signal used in identification (ID) setting, a first optional device to set a first ID corresponding to the first pulse signal upon receipt of the first pulse signal and to generate a second pulse signal, and a second optional device to set a second ID corresponding to the second pulse signal upon receipt of the second pulse signal and to generate a third pulse signal.

The first optional device or the second optional device may be a mailbox to separately load a printing medium discharged from the main body or a stacking device to stack the printing medium.

The first optional device may set the first ID corresponding to a number of pulses of the first pulse signal and the second optional device may the second ID corresponding to a number of pulses of the second pulse signal.

The first optional device may generate the second pulse signal to have a greater number of pulses than the number of pulses of the first pulse signal and the second optional device may generate the third pulse signal to have a greater number of pulses than the number of pulses of the second pulse signal.

The number of pulses of the second pulse signal may be greater by 1 than the number of pulses of the first pulse signal and the number of pulses of the third pulse signal may be greater by 1 than the number of pulses of the second pulse signal.

The main body may receive and register ID information from the first optional device and the second optional device.

The foregoing and/or other features and utilities of the present general inventive concept may also be achieved by providing a method to control an image forming apparatus including a main body and a plurality of optional devices connected electrically to the main body includes transmitting, at the main body, a first pulse signal to one of the optional devices connected to the main body, setting, at a first optional device receiving the first pulse signal, a first ID corresponding to the first pulse signal and generating and transmitting a second pulse signal to an adjacently connected optional device, setting, at a second optional device receiving the second pulse signal, a second ID corresponding to the second pulse signal and generating and transmitting a third pulse signal to an adjacently connected optional device, and repeating an operation of setting an ID corresponding to a received pulse signal and generating and transmitting a new pulse signal to an adjacently connected optional device until each of the plurality of optional devices has set respective IDs.

The optional devices may include a mailbox to separately load a printing medium discharged from the main body or a stacking device to stack the printing medium.

The first optional device may set the first ID corresponding to a number of pulses of the first pulse signal and the second optional device may set the second ID corresponding to a number of pulses of the second pulse signal.

The first optional device may generate the second pulse signal to have a greater number of pulses than the number of pulses of the first pulse signal and the second optional device may generate the third pulse signal to have a greater number of pulses than the number of pulses of the second pulse signal.

The number of pulses of the second pulse signal may be greater by 1 than the number of pulses of the first pulse signal and the number of pulses of the third pulse signal may be greater by 1 than the number of pulses of the second pulse signal.

The foregoing and/or other features and utilities of the present general inventive concept may also be achieved by providing an image forming apparatus including a controller to generate and transmit a pulse signal, and a first optional device to receive the pulse signal and set a first optional device identification (ID) according to the pulse signal, and to increment and transmit the pulse signal.

The image forming apparatus may further include one or more additional connected optional devices, wherein each of the additional optional devices receives, from an adjacent one of the additional optional devices, an incremented pulse signal and accordingly sets respective IDs, and further increments and transmits the incremented pulse signal.

The first optional device may transmit the first optional device ID to the controller.

Each of the optional devices are connected to the controller in a daisy chain configuration to receive the incremented pulse signal.

Each of the optional devices may be connected to the controller through a bidirectional connection to transmit the respective IDs to and receive control signals from the controller.

The foregoing and/or other features and utilities of the present general inventive concept may also be achieved by providing a method of controlling an image forming apparatus, the method including transmitting a pulse signal from a controller to a first optional device, setting an identification (ID) of the first optional device according to the received pulse signal, and incrementing the pulse signal and transmitting the incremented pulse signal so as to be received by a potential additional optional device.

The method may further include receiving the incremented pulse signal at a second optional device, and setting an ID of the second optional device according to the received incremented pulse signal and incrementing and transmitting the incremented pulse signal further along a daisy chain connection, wherein the receiving, incrementing, and transmitting of the incremented pulse signal continues until all connected optional devices have set IDs.

All of the connected optional devices may respectively transmit the set IDs to the controller through a bidirectional connection.

The controller may control all of the connected optional devices through signals sent through the bidirectional connection.

The foregoing and/or other features and utilities of the present general inventive concept may also be achieved by providing a computer readable medium having recorded thereon a program to control a computer to perform a method of controlling an image forming apparatus, the method including transmitting a pulse signal from a controller to a first optional device, setting an identification (ID) of the first optional device according to the received pulse signal, and incrementing the pulse signal and transmitting the incremented pulse signal so as to be received by a potential additional optional device.

The foregoing and/or other features and utilities of the present general inventive concept may also be achieved by providing a method of controlling an image forming apparatus, the method including receiving a signal, through a daisy chain connection, at each of a plurality of optional devices connected to the image forming apparatus; incrementing and transmitting the signal in response to receiving the signal, and setting respective identifications (IDs) of the optional devices according to the respective received signal.

The method may further include generating and transmitting the signal from a controller to the optional devices.

The method may further include transmitting, through a bidirectional connection, the set IDs from each of the respective optional devices to the controller.

The method may further include controlling the optional devices by the controller according to the respective set IDs.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is a diagram illustrating a schematic configuration of an image forming apparatus according to an exemplary embodiment of the present general inventive concept;

FIG. 2 is a diagram illustrating configurations of mailboxes of an image forming apparatus according to an exemplary embodiment of the present general inventive concept;

FIG. 3 is a schematic control block diagram of an image forming apparatus according to an exemplary embodiment of the present general inventive concept; and

FIG. 4 is a flow chart illustrating a control method to set IDs of three mailboxes of an image forming apparatus according to an exemplary embodiment of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to like elements throughout. The embodiments are described below in order to explain the present general inventive concept by referring to the figures.

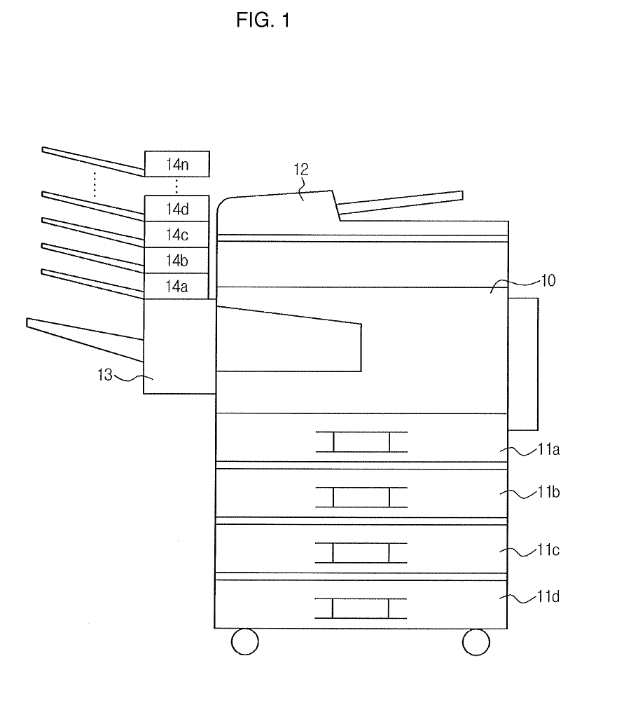

FIG. 1 is a diagram illustrating a schematic configuration of an image forming apparatus according to an exemplary embodiment of the present general inventive concept.

It will be understood that any of a variety of printing mediums may be used by an image forming apparatus of this exemplary embodiment of the present general inventive concept. Therefore, although paper is described as the printing medium employed in various exemplary embodiments described herein, it is apparent that any printing medium may be used.

As illustrated in FIG. 1, the image forming apparatus may include a main body 10, a plurality of paper stacking devices 11a, 11b, 11c, and 11d detachably installed at the lower side of the main body 10 to load various sizes of a printing medium such as paper, an automatic paper feeding device 12 installed at the upper side of the main body 10, a finisher 13 used to post-process discharged paper, and a plurality of mailboxes 14a to 14n detachably installed at a side of the main body 10.

The finisher 13 may punch, staple, and/or otherwise process discharged paper using a punch, stapler, etc., and may convey the paper to the mailboxes 14a to 14n.

The mailboxes 14a to 14n may separately load the conveyed paper on output trays according to user settings.

The paper stacking devices 11a, 11b, 11c, and 11d, the automatic paper feeding device 12, the finisher 13, and the mailboxes 14a to 14n may be controlled by a main controller which may perform overall control of the image forming apparatus. For example, the controller may control the mailboxes 14a to 14n such that discharged paper may be conveyed to one of the mailboxes 14a to 14n while paper is discharged.

Such a main controller may be provided in the image forming apparatus, or in a computer communicating with the image forming apparatus, such as by a wired or wireless connection.

Each of the mailboxes 14a to 14n may communicate with the image forming apparatus on a network simply by being connected to a connector. For example, each mailbox and the image forming apparatus may be connected by a daisy chain type of network communication connection scheme.

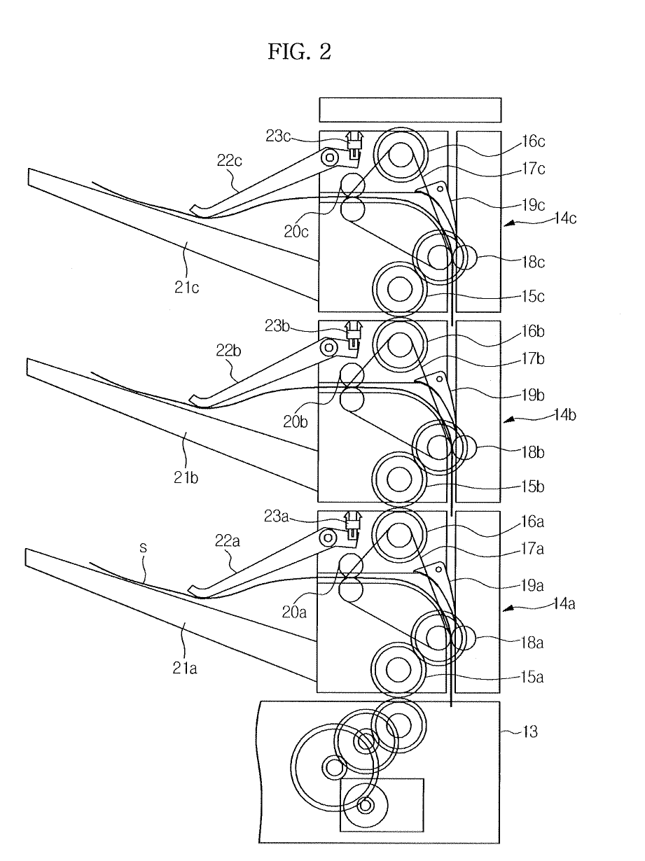

FIG. 2 is a diagram illustrating configurations of mailboxes of an image forming apparatus according to an exemplary embodiment of the present general inventive concept.

Although three mailboxes 14a, 14b, and 14c are illustrated in FIG. 2, it is understood that fewer or more than this number of mailboxes may be provided to an image forming apparatus according to the present general inventive concept.

As illustrated in FIG. 2, mailboxes 14a, 14b, and 14c may include first power transfer gears 15a, 15b, and 15c to receive power from the finisher 13, second power transfer gears 16a, 16b, and 16c to transfer power upwardly, driving belts 17a, 17b, and 17c, feed rollers 18a, 18b, and 18c, gates 19a, 19b, and 19c to direct paper S towards output trays 21a, 21b, and 21c, exit rollers 20a, 20b, and 20c, levers 22a, 22b, and 22c to move according to the amount of paper output to the output trays 21a, 21b, and 21c, and paper full sensors 23a, 23b, and 23c to sense whether the output trays 21a, 21b, and 21c are full of paper. A power transfer device including the first power transfer gears 15a, 15b, and 15c and the second power transfer gears 16a, 16b, and 16c may use other power transfer methods. For example, couplers may be used instead of the gears. In addition, a module including a motor may be additionally installed at the bottom of the mailboxes 14a-14c. As the number of stacked mailboxes is increased, the module may be installed at the middle of the mailboxes to distribute driving force. Alternatively, a plurality of such modules may be provided at respective various points between the mailboxes to distribute the driving force.

The mailboxes 14a, 14b, and 14c may drive the feed rollers 18a, 18b, and 18c and the exit rollers 20a, 20b, and 20c by driving force transferred upwardly from the bottom thereof to convey paper S. In this case, the mailboxes 14a, 14b, and 14c may operate the gates 19a, 19b, and 19c to change a conveying direction of the paper S so that the paper S may be discharged to a desired tray of the output trays 21a, 21b, and 21c.

In more detail, the mailboxes 14a, 14b, and 14c may respectively operate the gates 19a, 19b, and 19c to allow the paper P to either continuing traveling upward to the next adjacent one of the mailboxes, or may close the upward path to direct the paper P to be conveyed to the respective output trays 21a, 21b, and 21c.

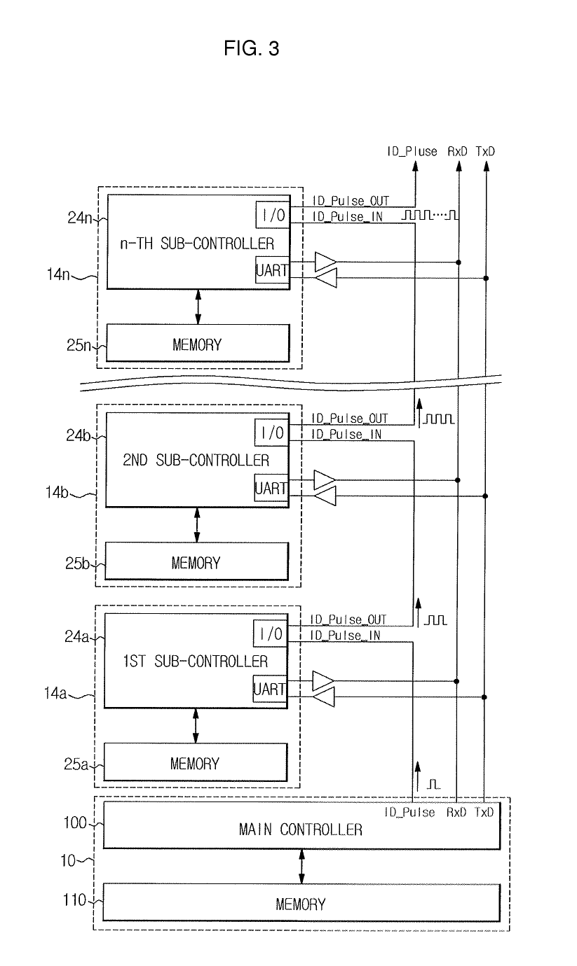

FIG. 3 is a schematic control block diagram of an image forming apparatus according to an exemplary embodiment of the present general inventive concept.

As illustrated in FIG. 3, the image forming apparatus may include a main controller 100 and a memory 110.

Mailboxes 14a to 14n may include sub-controllers 24a to 24n and memories 25a to 25n. The sub-controllers 24a to 24n may include input/output (I/O) ports and serial communication (for example, Universal Asynchronous Receiver Transmitter (UART)) ports.

The main controller 100 may be connected to each of the sub-controllers 24a to 24n so as to enable bi-directional communication through a bi-directional communication channel of the serial communication port, for example, the UART port, etc.

The main controller 100 may be connected to each of the sub-controllers 24a to 24n by a daisy chain scheme. A port of the main controller 100 that generates a pulse signal may be connected to the I/O port of the first sub-controller 24a of the first mailbox 14a. Accordingly, the pulse signal generated from the main controller 100 may be input to the I/O port of the first sub-controller 24a of the first mailbox 14a.

The I/O port of the first sub-controller 24a may be connected to the I/O port of the second sub-controller 24b of the second mailbox 14b. Accordingly, the pulse signal generated from the first sub-controller 24a may be input to the I/O port of the second sub-controller 24b of the second mailbox 14b. In a similar way, the sub-controllers of the other mailboxes may be connected to each other.

The first sub-controller 24a may set a corresponding identification (ID) by the pulse signal received from the main controller 100 and may store the ID in the memory 25a. The first sub-controller 24a may add or subtract pulses of a prescribed number to or from the pulse signal received from the main controller 100 and transmit the processed pulse signal to the second sub-controller 24b. The first sub-controller 24a may transmit the corresponding ID to the main controller 100 through the UART port.

The second sub-controller 24b may set a corresponding ID by the pulse signal received from the first sub-controller 24a and may store the ID in the memory 25b. The second sub-controller 24b may add or subtract pulses of a prescribed number to or from the pulse signal received from the first sub-controller 24a and transmit the processed pulse signal to the next sub-controller. The second sub-controller 24b may transmit the corresponding ID to the main controller 100 through the UART port. In a similar way, the subsequent sub-controllers may set IDs and transmit the IDs to the main controller 100.

The main controller 100 may receive ID information from the sub-controllers 24a to 24n through communication with the sub-controllers 24a to 24n via the UART ports and may store the ID information in the memory 110.

A method to set the ID of each mailbox will now be described. The main controller 100 may include a bi-directional communication channel such as UART so as to command driving of the mailboxes 14a to 14n and to receive the states of the mailboxes 14a to 14n and may assign IDs to the mailboxes 14a to 14n through a pulse output (ID_Pulse) port which generates a pulse signal.

If a power of the main body 10 of the image forming apparatus is turned on, the main body 10 may transmit one pulse, for example, one high active or low active pulse to the first mailbox 14a connected to the main body 10 through the pulse output (ID_Pulse) port. The first mailbox 14a (refer to FIG. 3) may receive the pulse through an ID_Pulse_IN port and count an active interval. The first mailbox 14a may store an ID corresponding to the count number and inform the main body 10 through the UART port that the first mailbox 14a has been connected.

For example, the first mailbox 14a may receive one pulse from the main body 10 and set an ID to 1. Next, the first mailbox 14a may inform the main body 10 that the first mailbox 14a has been connected by transmitting ID1 to the main body 10. The first mailbox 14a setting the ID may transmit two pulses obtained by adding one to the number of pulses received through the ID_Pulse_IN port to the second mailbox 14b.

The second mailbox 14b receiving the two pulses may set an ID to 2 and inform the main body 10 that the second mailbox 14b has been connected by transmitting ID2 to the main body 10. The second mailbox 14b setting the ID may transmit three pulses obtained by adding one to the number of pulses received through the ID_Pulse_IN port to the next neighbor mailbox, and so on. Whenever a pulse passes through the next mailbox, the number of pulses may be increased. In this way, (n+1) pulses are transmitted from the last mailbox 14n after checking all of the mailboxes 14a to 14n. However, since no mailboxes are present after the last mailbox 14n, the main body 10 may await a further response after confirming that the last mailbox 14n has been connected. If there is no response for a prescribed time, the main body 10 may end the assignment of IDs to the mailboxes 14a to 14n. The main body 10 may independently control the mailboxes 14a to 14n using the IDs of the mailboxes 14a to 14n assigned by the above-described ID setting method.

Hereinafter, a description of the ID setting method will be given with respect to three mailboxes by way of example.

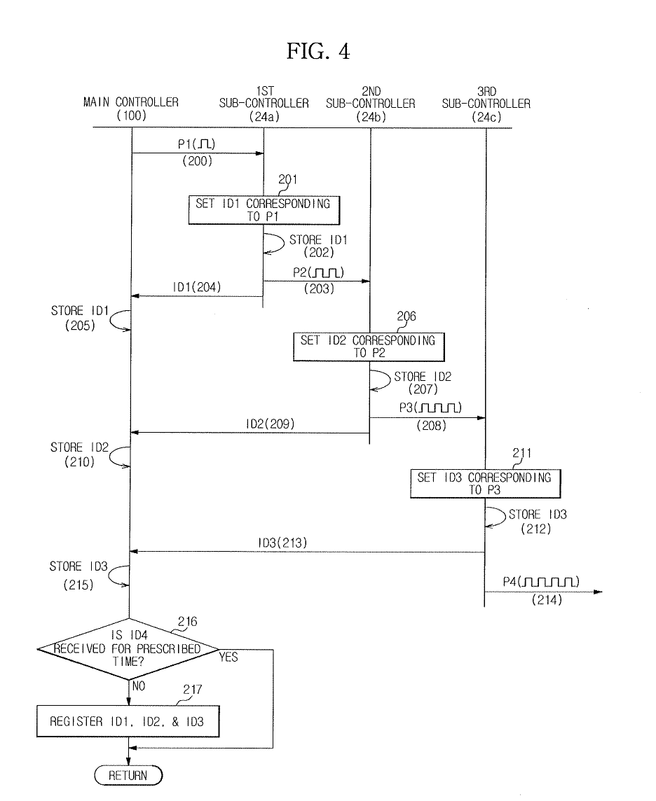

FIG. 4 is a flow chart illustrating a control method to set IDs of three mailboxes of an image forming apparatus according to an exemplary embodiment of the present general inventive concept.

Referring to FIG. 4, the main controller 100 may transmit a first pulse signal P1 having one pulse to the first sub-controller 14a in operation 200.

The first sub-controller 24a may receive the first pulse signal P1 and set ID1 corresponding to the first pulse signal P1 as an ID of the first mailbox 14a in operation 201. The first sub-controller 24a may store the set ID in the memory 25a in operation 202.

The first sub-controller 24a may transmit, to the second sub-controller 24b, a second pulse signal P2 obtained by adding one to the first pulse signal P1 received from the main controller 100 in operation 203.

The first sub-controller 24a may transmit ID1 which is the set ID of the first mailbox 14a to the main controller 100 in operation 204. The main controller 100 may receive the set ID (ID1) and store ID1 in the memory 110 in operation 205. Therefore, the main controller 100 may recognize that the first mailbox 14a has been connected and may discern ID information which is to be used when controlling the first mailbox 14a.

The second sub-controller 24b may receive the second pulse signal P2 and set ID2 corresponding to the second pulse signal P2 as an ID of the second mailbox 14b in operation 206.

The second sub-controller 24b may store the set ID in the memory 25b in operation 207. The second sub-controller 24b may transmit ID2 to the main controller 100 and may transmit, to the third sub-controller 24c, a third pulse signal P3 obtained by adding one to the second pulse signal P2 received from the first sub-controller 24a in operation 208.

The second sub-controller 24b may transmit ID2 which is the set ID of the second mailbox 14b to the main controller 100 in operation 209. The main controller may receive ID2 and store ID2 in the memory 110 in operation 210. Therefore, the main controller 100 may recognize that the second mailbox 14b has been connected and may discern ID information which is to be used when controlling the second mailbox 14b.

The third sub-controller 24c may receive the third pulse signal P3 and set ID3 corresponding to the third pulse signal P3 as an ID of the third mailbox 14c in operation 211.

The third sub-controller 24c may store the set ID in the memory 25c in operation 212. The third sub-controller 24c may transmit ID3 which is the set ID of the third mailbox 14c to the main controller 100 in operation 213.

The third sub-controller 24c may generate a fourth pulse signal P4 obtained by adding one to the third pulse signal P3 received from the second sub-controller 24b in operation 214.

The main controller may receive ID3 and store ID3 in the memory 110 in operation 215. Therefore, the main controller 100 may recognize that the third mailbox 14c has been connected and may discern ID information which is to be used when controlling the third mailbox 14c.

If ID4 is not received during a prescribed time in operation 216, the main controller may register ID1, ID2, and ID3 in operation 217 and terminate the the assignment of IDs to the mailboxes 14a to 14n.

As is apparent from the above description, IDs of various optional devices such as a plurality of mailboxes or paper stacking devices mounted in the image forming apparatus may be automatically set. Therefore, convenience of installation of the optional devices is improved and malfunction due to incorrect installation may be prevented.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. An image forming apparatus comprising:
a main body to generate a first pulse signal used in identification (ID) setting;
a first optional device to set a first ID corresponding to the first pulse signal upon receipt of the first pulse signal and to generate a second pulse signal; and
a second optional device to set a second ID corresponding to the second pulse signal upon receipt of the second pulse signal and to generate a third pulse signal.

2. The image forming apparatus according to claim 1, wherein the first optional device or the second optional device is a mailbox to separately load a printing medium discharged from the main body or a stacking device to stack the printing medium.

3. The image forming apparatus according to claim 1, wherein the first optional device sets the first ID corresponding to a number of pulses of the first pulse signal and the second optional device sets the second ID corresponding to a number of pulses of the second pulse signal.

4. The image forming apparatus according to claim 3, wherein the first optional device generates the second pulse signal to have a greater number of pulses than the number of pulses of the first pulse signal and the second optional device generates the third pulse signal to have a greater number of pulses than the number of pulses of the second pulse signal.

5. The image forming apparatus according to claim 4, wherein the number of pulses of the second pulse signal is greater by 1 than the number of pulses of the first pulse signal and the number of pulses of the third pulse signal is greater by 1 than the number of pulses of the second pulse signal.

6. The image forming apparatus according to claim 1, wherein the main body receives and registers ID information from the first optional device and the second optional device.

7. A method to control an image forming apparatus including a main body and a plurality of optional devices connected electrically to the main body, the method comprising:
transmitting, at the main body, a first pulse signal to one of the optional devices connected to the main body;
setting, at a first optional device receiving the first pulse signal, a first identification (ID) corresponding to the first pulse signal and generating and transmitting a second pulse signal to an adjacently connected optional device;
setting, at a second optional device receiving the second pulse signal, a second ID corresponding to the second pulse signal and generating and transmitting a third pulse signal to an adjacently connected optional device; and
repeating an operation of setting an ID corresponding to a received pulse signal and generating and transmitting a new pulse signal to an adjacently connected optional device until each of the plurality of optional devices has set respective IDs.

8. The method according to claim 7, wherein the optional devices include a mailbox to separately load a printing medium discharged from the main body or a stacking device to stack the printing medium.

9. The method according to claim 8, wherein the first optional device sets the first ID corresponding to a number of pulses of the first pulse signal and the second optional device sets the second ID corresponding to a number of pulses of the second pulse signal.

10. The method according to claim 9, wherein the first optional device generates the second pulse signal to have a greater number of pulses than the number of pulses of the first pulse signal and the second optional device generates the third pulse signal to have a greater number of pulses than the number of pulses of the second pulse signal.

11. The method according to claim 10 wherein the number of pulses of the second pulse signal is greater by 1 than the number of pulses of the first pulse signal and the number of pulses of the third pulse signal is greater by 1 than the number of pulses of the second pulse signal.

12. An image forming apparatus comprising:
a controller to generate and transmit a pulse signal; and
a first optional device to receive the pulse signal and set a first optional device identification (ID) according to the pulse signal, and to increment and transmit the pulse signal.

13. The image forming apparatus of claim 12, further comprising:
one or more additional connected optional devices;
wherein each of the additional optional devices receives, from an adjacent one of the additional optional devices, an incremented pulse signal and accordingly sets respective IDs, and further increments and transmits the incremented pulse signal.

14. The image forming apparatus of claim 12, wherein the first optional device transmits the first optional device ID to the controller.

15. The image forming apparatus of claim 13, wherein each of the optional devices are connected to the controller in a daisy chain configuration to receive the incremented pulse signal.

16. The image forming apparatus of claim 13, wherein each of the optional devices is connected to the controller through a bidirectional connection to transmit the respective IDs to and receive control signals from the controller.

17. A method of controlling an image forming apparatus, the method comprising:
transmitting a pulse signal from a controller to a first optional device;
setting an identification (ID) of the first optional device according to the received pulse signal; and
incrementing the pulse signal and transmitting the incremented pulse signal so as to be received by a potential additional optional device.

18. The method of claim 17, further comprising:
receiving the incremented pulse signal at a second optional device; and
setting an ID of the second optional device according to the received incremented pulse signal and incrementing and transmitting the incremented pulse signal further along a daisy chain connection; wherein
the receiving, incrementing, and transmitting of the incremented pulse signal continues until all connected optional devices have set IDs.

19. The method of claim 18, wherein all of the connected optional devices respectively transmit the set IDs to the controller through a bidirectional connection.

20. The method of claim 19, wherein the controller controls all of the connected optional devices through signals sent through the bidirectional connection.
